(19) United States
(12) Patent Application Publication
(10) Pub. No.: US 2005/0161172 A1
(43) Pub. Date: Jul. 28, 2005

(54) ROLLER MOUNTING SYSTEM OF A ROLLING DOOR ASSEMBLY

(75) Inventor: Andrew Rekret, North York (CA)

Correspondence Address: Douglas S. Johnson;C/O DENNISON ASSOCIATES, SUITE 301, 133 RICHMOND ST. WEST, TORONTO, ON, M5H 2L7, CA

(73) Assignee: MASTERCORE TECHNOLOGIES LTD.

(21) Appl. No.: 10/765,035

(22) Filed: Jan. 28, 2004

(51) Int. Cl. E05D 15/06

(52) U.S. Cl. 160/201

(57) ABSTRACT

A rolling door assembly includes first and second corresponding plastic panels secured to one another by hinged panel interlock. Each panel has first and second interlock parts to each of the upper and lower sides of each panel. The hinged panel interlock is formed by the first interlock part of the first panel securing with the second interlock part of the second panel. Each panel has an edge opening remotely of the hinged panel interlock in opposite ends of each panel. Each panel opening is fitted with an insert having an elongated cylindrical bore which receives an axle of a door roller having a roller head along the side edge of the door assembly.

### FIELD OF THE INVENTION

The present invention relates to a rolling door assembly used to cover an enclosure opening.

### BACKGROUND OF THE INVENTION

Rolling doors have been used for many years to cover enclosures such as garages. They are further used at the rear of large truck trailers.

In the past most rolling doors have had a wooden construction i.e., each of the panels hingedly secured to one another in forming the door have been made of wood. Metal hardware is then screwed to the interior surface of the wooden panels for mounting the rollers to the conventional wood rolling door.

More recently, plastic panels have been used in forming a rolling door. These plastic panels are secured by a hinged interlock. It is known with plastic panels to mold the panel with a shape such that the interlocking hinge portions between the panels are an integral part of each panel. Hardware for mounting the rollers to the plastic panels is then typically secured to the interior face of the door forming panels.

It is however also known to fit roller axles into opposite side edges of a plastic panel door. According to this known roller mounting system openings conforming to the size of the roller axle are provided directly at the interlock between the panels.

The fitting of the roller axle directly into the panel joint typically requires thinning of the plastic material of each of the panels at the joint. This weakens the overall strength of the door.

### SUMMARY OF THE PRESENT INVENTION

The present invention provides a rolling door assembly made of plastic panels hingedly interlocked to one another and incorporating rollers which secure into the opposing side edges of the door. The rollers which are located at or near the hinged interlock between adjacent panels do not fit directly into the actual panel. Rather the rollers are mounted by reinforcing inserts into the opposite side edges of the door. The inserts do not detract from but rather enhance the strength of the door at the hinged joints between the panels.

More particularly, a rolling door assembly according to the present invention comprises at least first and second corresponding plastic panels secured to one another by a hinged panel interlock. Each panel has first and second interlock parts to opposite sides of each panel. The hinged panel interlock is formed by the first interlock part of the first panel securing with the second interlock part of the second panel.

Each panel has an edge opening remotely of the hinged panel interlock in the opposite ends of each panel. Each panel opening is fitted with an insert which includes an insert part having an elongated cylindrical bore. The bore of the insert part receives the axle of a door roller having a roller head adjacent to the side edge of the door assembly.

### BRIEF DESCRIPTION OF THE DRAWINGS

The above as well as other advantages and features of the present invention will be described in greater detail according to the preferred embodiments of the present invention in which;

FIG. 1 is a perspective view looking down on the rear of a truck trailer fitted with a rolling plastic door assembly according to a preferred embodiment of the present invention;

FIG. 2 is an exploded perspective view of two of the panels from the door assembly of FIG. 1;

FIG. 3 is a perspective view of the upper end region of the door of FIG. 1;

FIG. 4 is an exploded perspective view of a roller and roller mounting insert from the door of FIG. 1;

FIG. 5 is a side view of the upper end of the door shown in FIG. 3;

FIG. 6 is a side view of a wiper seal from the upper end of the door of FIG. 3;

FIG. 7 is a perspective view of the seal of FIG. 6 mounted to the upper end of the door of FIG. 3;

FIG. 8 is cross sectional view looking down through the door of the truck of FIG. 1;

FIG. 9 is a perspective view of a door assembly according to yet another preferred embodiment of the present invention;

FIG. 10 is an exploded perspective view showing the roller and roller mounting inserts from the door of FIG. 9;

FIG. 11 is an enlarged perspective view of the interlock end of one of the panels from the door of FIG. 9;

FIG. 12 is an enlarged perspective view of the bottom end seal of the door of FIG. 9;

FIG. 13 is an enlarged perspective view of the cable mount with included roller of FIG. 9;

FIG. 14 is a perspective view of one of the components of the cable mount of FIG. 13;

FIG. 15 is a perspective view showing a partial assembly of the cable mount of FIG. 13;

FIG. 16 is a perspective view of a further component of the cable mount of FIG. 13; and

FIG. 17 is a perspective view showing the fitting of the cable mounting component of FIG. 16 with the assembly of FIG. 15.

### DETAILED DESCRIPTION ACCORDING TO THE PREFERRED EMBODIMENTS OF THE PRESENT INVENTION IN WHICH

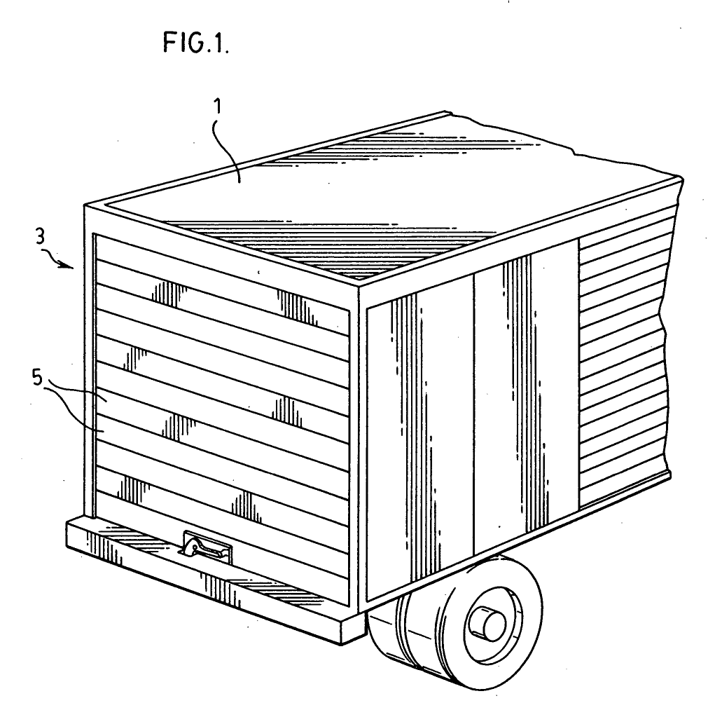

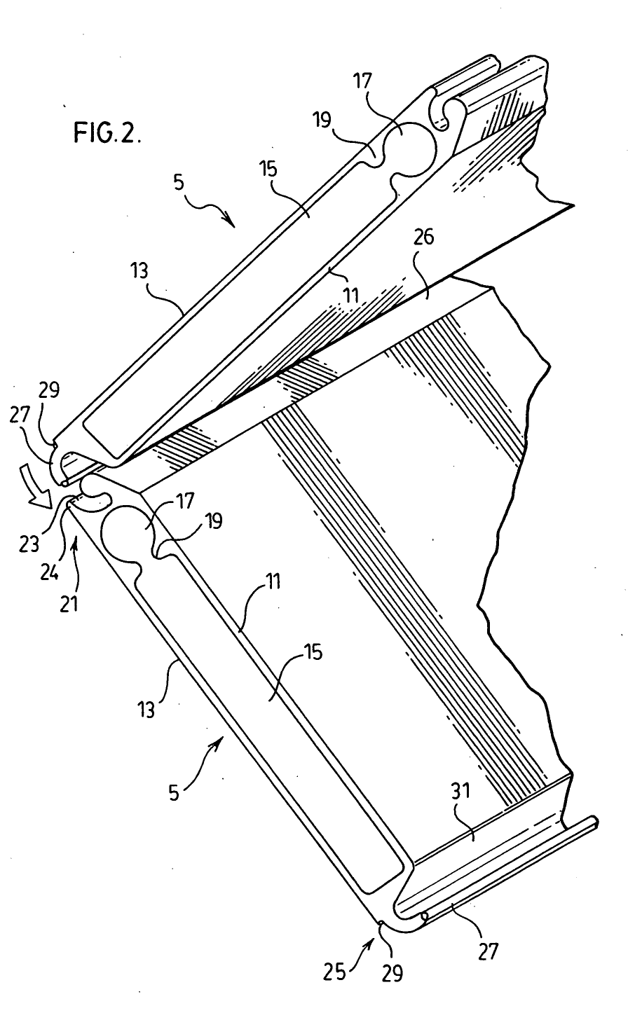

FIG. 1 shows a truck trailer 1 provided with a rear closure door generally indicated at 3. This door which is known in the industry as a rolling or articulated door is formed from a plurality of hingedly interlocked plastic panels indicated at 5 in FIG. 2 of the drawings. These two panels are identical to one another in construction.

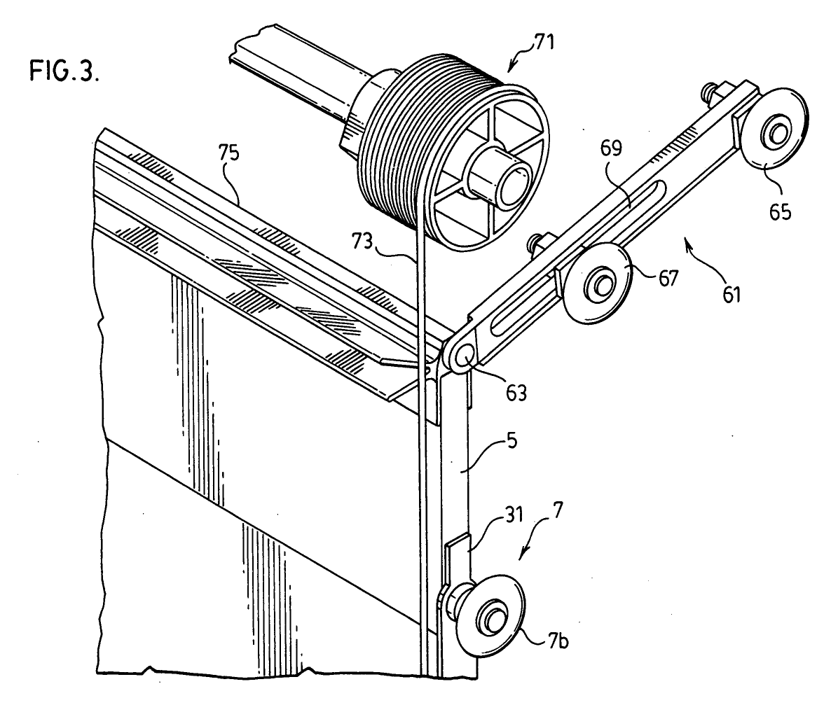

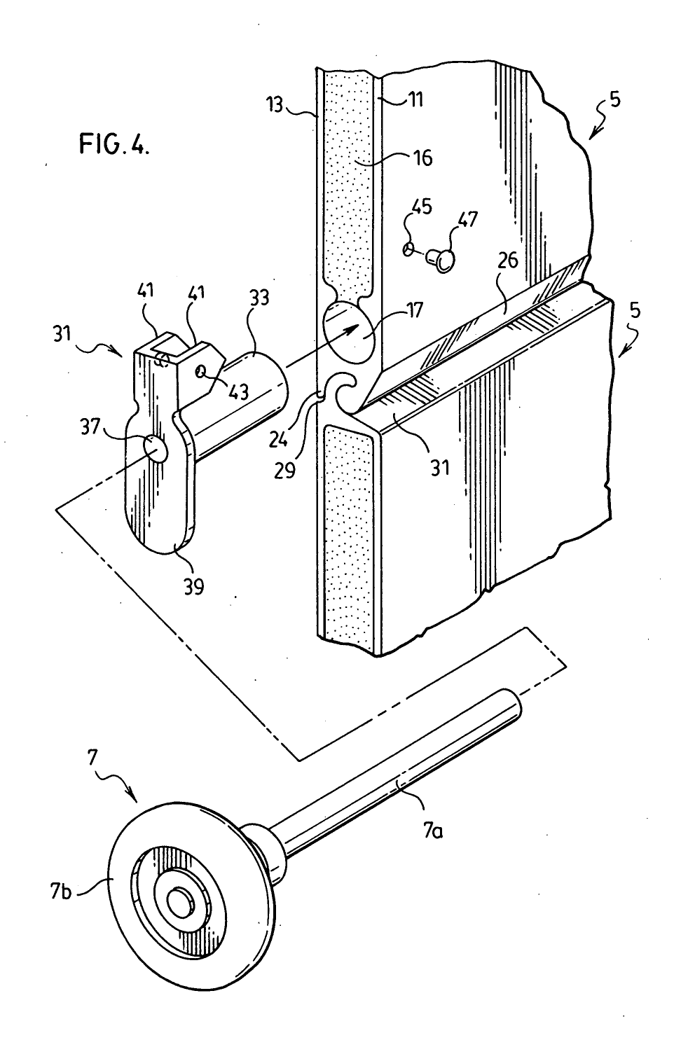

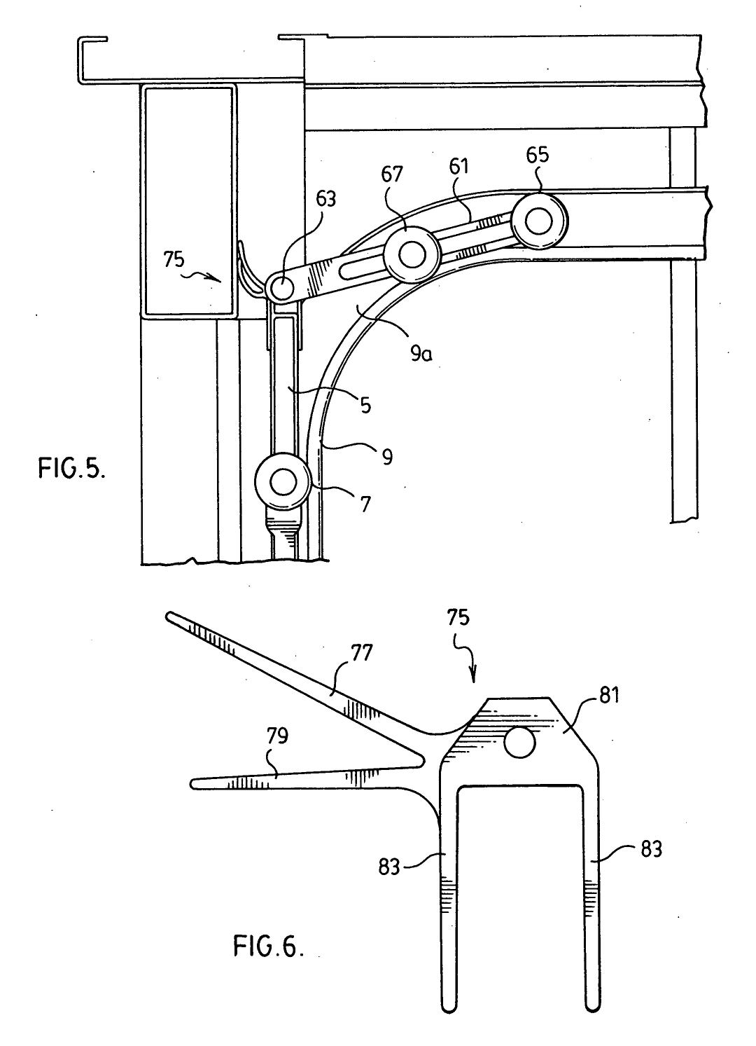

Each of the plastic door panels is fitted to its opposite ends with a door roller generally indicated at 7 in FIGS. 3 and 4 of the drawings. The interior of the truck is provided with a track 9 seen in FIG. 5 of the drawings. Rollers 7 locate within and ride along track 9 as door 3 is opened and closed.

Referring now to FIGS. 2 and 4 of the drawings it will be seen that each of the panels has a one piece generally hollow construction. This construction may be formed by a continuous extrusion or even a continuous pultrusion panel forming method. The panels are then cut to an appropriate length for spanning the opening across the rear of the truck body.

The material used to form each of the panels is preferably polyvinyl chloride with additional strengthening filler ingredients such as fiberglass or the like.

Each panel includes an inner wall 11 and an outer wall 13 separated by the hollow interior of the panel. This hollow interior is divided into a main hollow region 15 and a much more minor hollow region 17. Hollow regions 15 and 17 are separated from one another by a neck part 19 of the panel.

Panel edge regions 21 and 25 are provided to the opposite top and bottom sides of each panel. Edge region 21 includes a curved slot 23 while edge region 25 includes a curved tail 27. The tail 27 of edge region 25 of the upper panel secures within the slot 23 of edge region 21 of the lower panel shown in FIG. 2 in forming a hinged interlocking joint between the two panels.

The interlocking joint described immediately above can only hinge in one direction i.e., in a direction such that the interior walls 11 of the panels are allowed to fold inwardly at one another. This folding is allowed as a result of edge region 21 having a sloped face 26 and edge region 25 having a sloped face 31. These two sloped faces are inclined outwardly away from one another when the panels are in their FIG. 4 aligned position. This provides clearance for the panel to fold inwardly relative to one another.

The panels will not fold outwardly past the FIG. 4 position due to the provision of stop 24 at panel edge 21 and stop 29 at panel edge 25. These two stops move against one another when the panels are aligned to prevent outward~folding of the door.

As can be well seen in FIG. 4 of the drawings when the slot 23 of one of the panels is filled in with the tail 27 of the other panel the interlocked joint has a solid rather than a hollow construction. As such, the joint rather than being weakened is in fact a relatively strong solid plastic region in the door assembly. This is to be contrasted to some known plastic rolling doors where the joint includes a hollow part extending completely along one of the panels to receive an axle of a roller to be fitted into the door at the joint.

FIG. 4 of the drawings shows an insert generally indicated at 31 which is used to mount the roller 7 to the door assembly. Insert 31 preferably has an injection molded construction made from a strong and durable nylon material or the like. As such, the insert adds to the strength of the door where the roller is mounted to the door.

Insert 31 comprises an elongated cylindrical plug portion 33 which snugly press fits into the generally circular opening to hollow chamber 17 in the end of the panel. Neck part 16 of the panel and the hinged interlock trap the plug 33 from sliding along the panel out of hollow region 17.

As seen in FIG. 4 of the drawings hollow region 15 of the panel is preferably filled with a reinforcing foam material 16 to add to the strength of the main body of the panel. Insert 31 includes piercing tabs 41 provided with fastener receiving openings 43. These two piercing tabs penetrate the foam material 16 when the plug portion 33 of the insert is forced into chamber region 17. The tabs locate internally of the panel against the panel walls 11 and 13. Wall 11 is provided with an opening 45 that aligns with the openings 43 of tabs 41. A mechanical fastener 47 is then fitted through the openings 45 and 43 to lock insert 31 onto the edge of the door.

The insert further includes a face portion 39 perpendicular to plug portion 33. This face portion presses against the side edge of the door and acts as a stop to properly locate tabs 41 such that the openings in these tabs align with the opening 45 in the panel wall.

It should be noted that face portion 39 does not interlock with the lower panel shown in FIG. 4 of the drawings and therefore does not inhibit the pivoting or swinging action between the two panels.

Plug portion 43 of insert 31 includes an elongated cylindrical bore 37. This bore receives the cylindrical axle 7a of roller 7. As such, plug portion 33 provides a roller bearing.

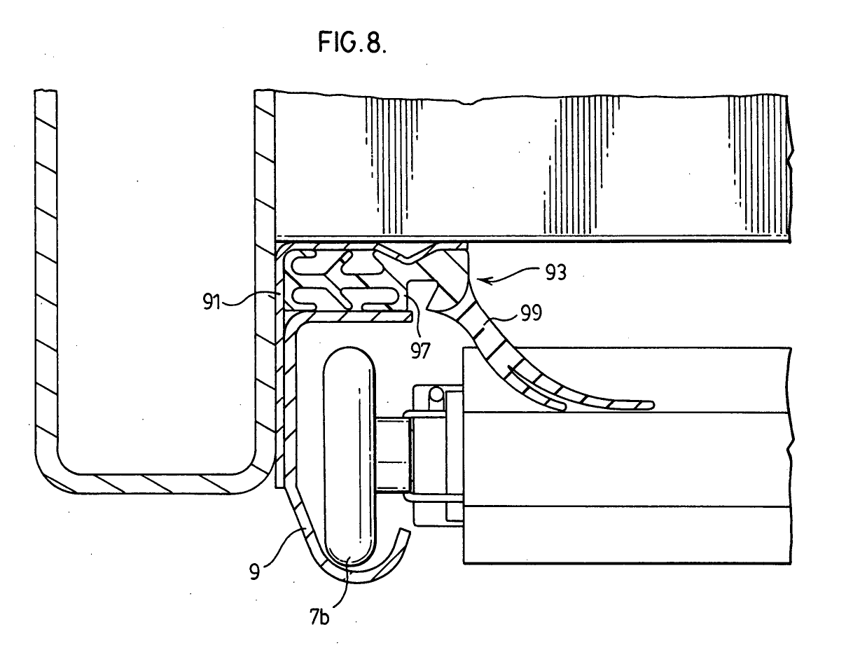

With the axle 7a of roller 7 fitted into insert 31 the roller head 7b is positioned at the door edge to fit into and ride along the guide track. This guide track is mounted to the interior of the truck body as seen in both FIGS. 5 and 8 of the drawings.

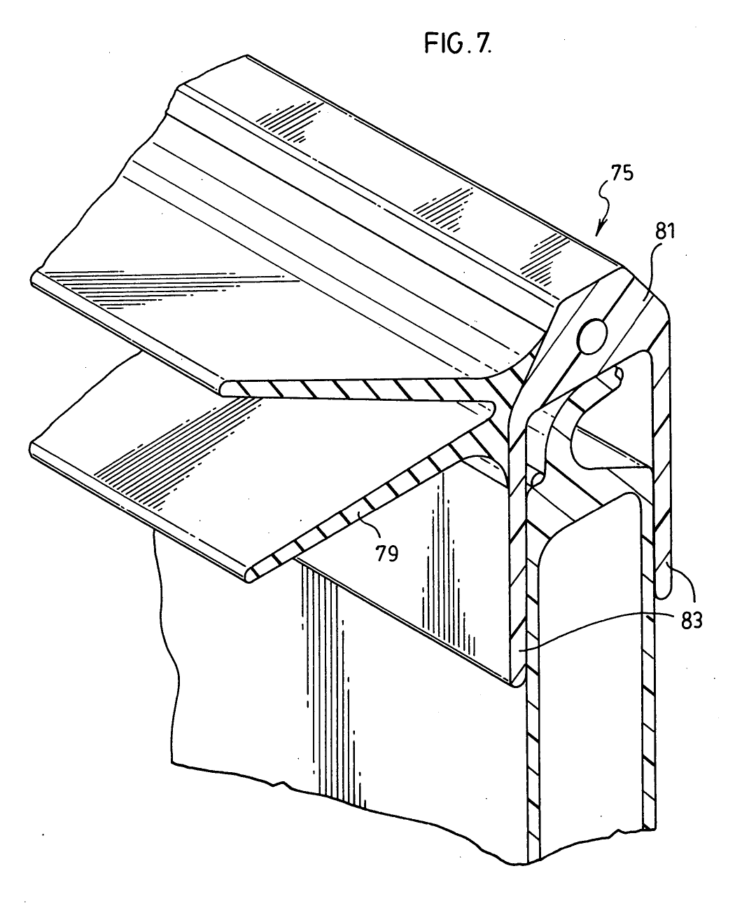

FIGS. 3, 5, 7 and 8 show further preferred features of the door assembly. One of these features comprises a track guide generally indicated at 61 pivotally secured at 63 at each side of the upper end of the door. This track guide includes first and second rollers 65 and 67. Roller 67 is secured within an elongated slot 69 of the track guide. This allows roller 67 to be adjusted lengthwise of the track guide to a desired position and then tightened in that position. The positioning of the track guide will depend upon the size of the panels in the door and the degree of clearance that the panels have at the upper end of the door.

As will be appreciated the upper end of the rolling door will be located as close as possible to the roof of the truck trailer. This is done for purposes of maximizing the amount of space available in the trailer. However, the high positioning of the guide track near the trailer roof limits the clearance area in which the panels need to swing from their vertically extending closed panel positions to their horizontally extending open panel positions. These two panel positions are shown in FIG. 5 of the drawings. As is also shown in FIG. 5 of the drawings, panel guide 61, due to the provision of the pair of spaced apart rollers 65 and 67 which are also trapped in track 9, makes a very quick turning action from vertical to horizontal as the panel guide turns around the corner region 9a of channel 9. The panel guide through its pivotal connection 63 with the upper end of the panel 5 then quickly changes the direction of the top panel of the door from horizontal to vertical minimizing the space requirements at the upper end of the door assembly.

FIGS. 5, 6 and 7 show a further preferred feature of the assembly comprising a cap 75 secured to the upper edge of the upper most panel 5 in the door assembly. This cap comprises a relatively rigid body portion 81 having a pair of spaced apart legs 83. Legs 83 secure to the opposite outside faces of the panel.

Extending from body portion 81 are a pair of flexible wiper seals 77 and 79. These wiper seals as best seen in FIG. 5 flex against the interior surface of the truck body when the door is in its closed position. The wiper seals prevent debris and moisture from entering the trailer past the upper edge of the rolling door.

FIG. 8 shows a further sealing member generally indicated at 93 against the external surface of the door when the door is in its closed position. Seal 93 has a relatively rigid base 97 that mounts into a housing 91 supported by the track 9 along the vertical length of the track. Seal 93 further includes flexible wipers 99 which are pressed against the external surface of the door protecting both the tracks and the door rollers from exposure to external elements when the door is closed.

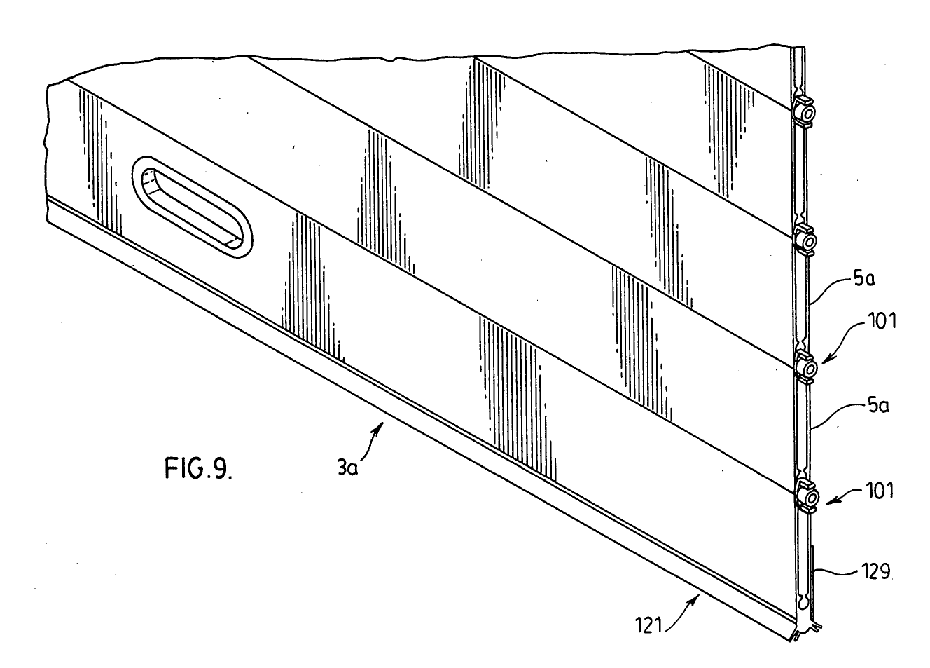

FIGS. 9 through 11 of the drawings show a further preferred embodiment for mounting rollers 101 to a door assembly 3a. This door assembly comprises a plurality of plastic panels 5a hingedly interlocked edge to edge to one another.

Panels 5a have a very similar construction to the earlier described panels 5 shown in FIG. 2 of the drawings. In fact, panels 5a start with the identical construction to panels 5 and are then slightly modified to receive a roller mounting insert 51.

Each of the panels 5a includes a main hollow region 15a between the internal and external walls 11a and 13a of panel 5a.

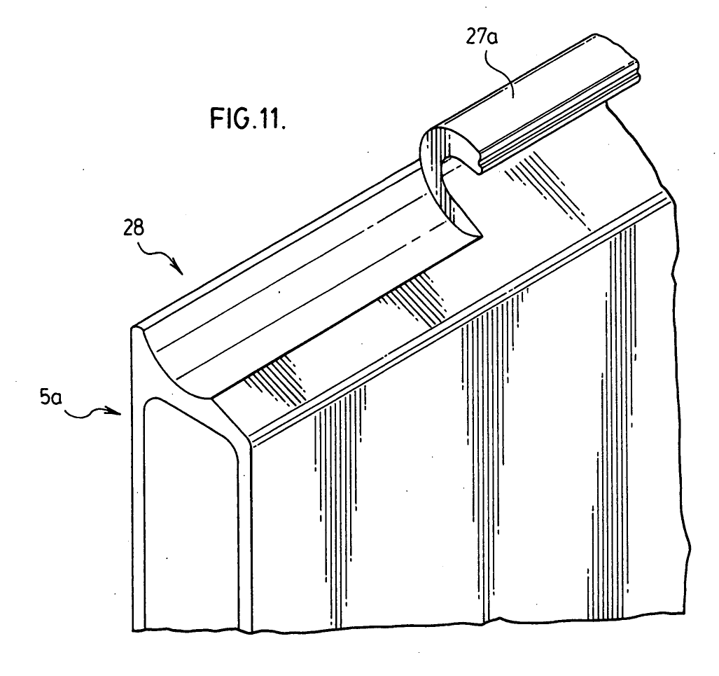

Like the earlier described panel, each of the panels 5a has one side edge provided with a curved tail and the other side edge provided with a correspondingly curved receiving slot. FIG. 11 shows the tail 27a at one edge of the panel. The other edge of the panel includes a slot which will receive the tail 27a of an adjacent panel. This forms the hinged interlock between the two panels.

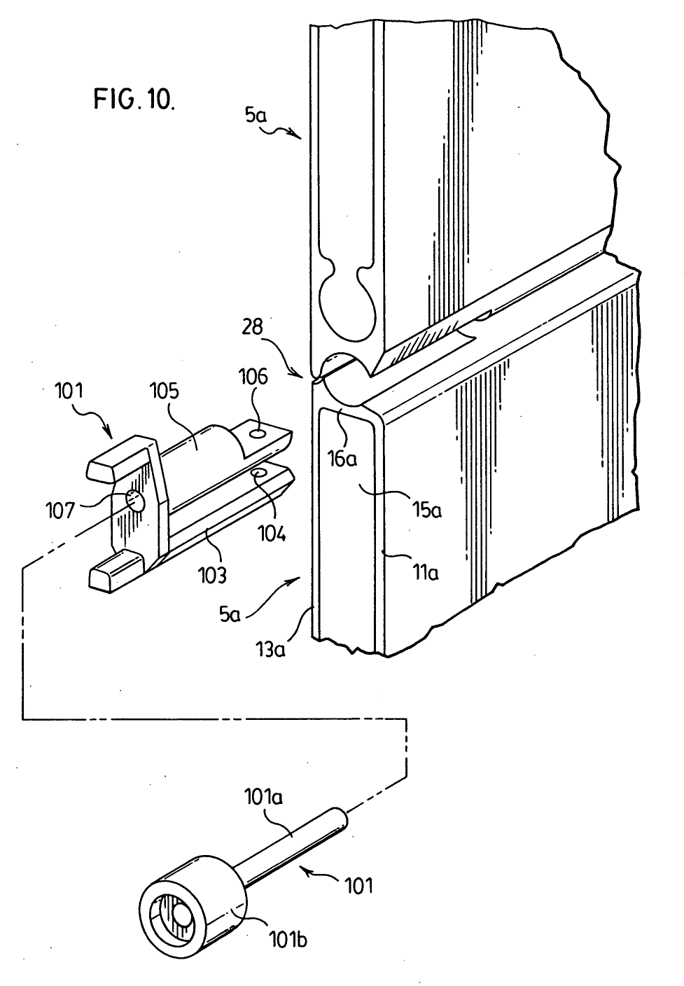

Unlike the earlier described panel tail 27a does not extend completely across the panel but rather terminates short of the panel end to produce a panel joint recess generally indicated at 28. This recess which is best seen in FIG. 10 of the drawings is provided at each side of each panel i.e., the side edge of the panel including the tail receiving slot is also recessed.

The recess 28 is provided by first forming the panel edge with either the tail or the slot containing part of the panel edge extending fully across the panel i.e., to have a shape identical to panel 5. From here, material is cut away from each of the panel edges to opposite sides of each panel. However, the amount of material cut away is only that needed to receive the roller mounting insert 51 described below. This leaves the remainder of the hinged interlocked joint which occupies almost all of the width across the door once again as a solid component of the door assembly. In other words, the very minor amount of recessing required has little if any detrimental effect with respect to the strength of the door assembly. The inclusion of the insert in the door assembly at the recess in fact adds to the strength of the joint.

Like the earlier described insert 31, insert 51 is preferably made in an injection molding operation and formed from durable relatively rigid nylon material to beef up or strengthen the panel joint.

Insert 101 includes a first plug portion 103 and a second plug portion 105. Plug portion 103 pushes into the hollow region 15a of panel 5a.

The second plug portion 105 pushes into the hollow region 28 between the edge to edge panels. The edge wall part 16a of the panel is sandwiched between plug portions 103 and 105. These two plug portions include aligned openings 104 and 106 positioned to opposite sides of panel wall portion 16a. A mechanical fastener is then fitted into opening 106 and passed through wall portion 16a of the panel to engage within the opening 104 of plug portion 103. This secures the insert within the door assembly.

Like the earlier described embodiment, insert 51 uses a plug portion which slides into a panel end opening i.e., plug portion 103 which slides into the opening to hollow region 15a located away from the panel interlock joint for mounting the insert to the panel. However, in this case, the second plug portion 105 is additionally provided aligned with the joint. It is this second plug portion 105 which includes an elongated cylindrical bore 107 to receive the axle part 101a of roller 101. The roller head 101b then protrudes from the side edge of the door to be fitted into a roller guide track for the assembly.

Even though the actual mounting position for the roller axle is aligned with the panel joint, the joint itself remains extremely strong. This is because the mounting of the roller axle is provided by the insert fitted into a relatively short recess designed specifically to receive the insert. This is to be contrasted to a traditional extruded panel designed to receive a roller at the interlock point. The conventional practice because of extrusion forming requirements is to make the joint forming panel edge hollow over the entire length of the panel substantially weakening the interlock between panels. Such is not the case when using the embodiment shown in FIG. 10 of the drawings.

The reason for using the two different rollers 7 and 101 shown in FIGS. 4 and 10 respectively is that these rollers have different sizes of roller heads. Roller 7 has a relatively large roller head usable with a rolling door having a relatively large space clearance at the top of the door where the panels swing between their vertical and horizontal positions. The smaller headed roller 101 shown in FIG. 10 of the drawings is used with a door assembly on a truck such as a beverage truck where there is less track clearance at the upper end of the door.

Further embodiments of the invention are shown having a respect to FIGS. 9 and 12 through 17 of the drawings.

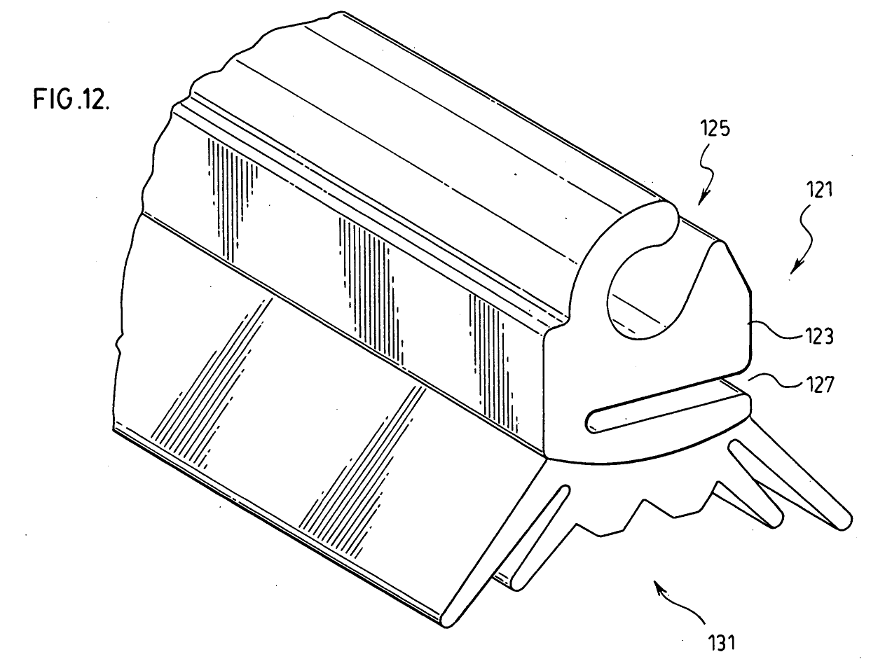

More particularly, it will be seen that door assembly 3a includes a bottom cushioning seal generally indicated at 121. This seal best seen in FIG. 12 includes a rigid body portion 123 having a curved slot opening 125. This curved slot opening is the same shape as slot opening 23 at the side edge of each of the panels. As such, seal 121 secures to the bottom edge of the lowest panel in the door assembly by the fitting of the curved tail 27a of the panel within the seal slot 125 to form an interlocked joint between the seal and the end of the panel. However, this is a fixed rather than a hinged interlock. A plate 129 is secured to the inside surface of the door and includes a tongue which penetrates into a further slot 127 in the rigid body portion 123 of seal 121. This locks the seal from rocking relative to the panel.

The bottom part of the seal includes a plurality of flexible sealing fins 131 that both cushion the descent of the door onto the floor of the trailer and seal the door from outside elements passing beneath the closed door.

FIGS. 3 and 13 through 17 show yet another preferred feature of the present invention.

Referring first to FIG. 3 it will be seen that a winding device generally indicated at 71 is provided above the door assembly for raising and lowering the door. This winding device includes a cable 73 which secures to the bottom end of the door as best shown in FIG. 13 of the drawings. The attachment of the cable to the door is provided by a cable mounting assembly generally indicated at 151. There is both a cable and one of these assemblies provided to each side of the door. This provides for a balanced raising and lowering of the door.

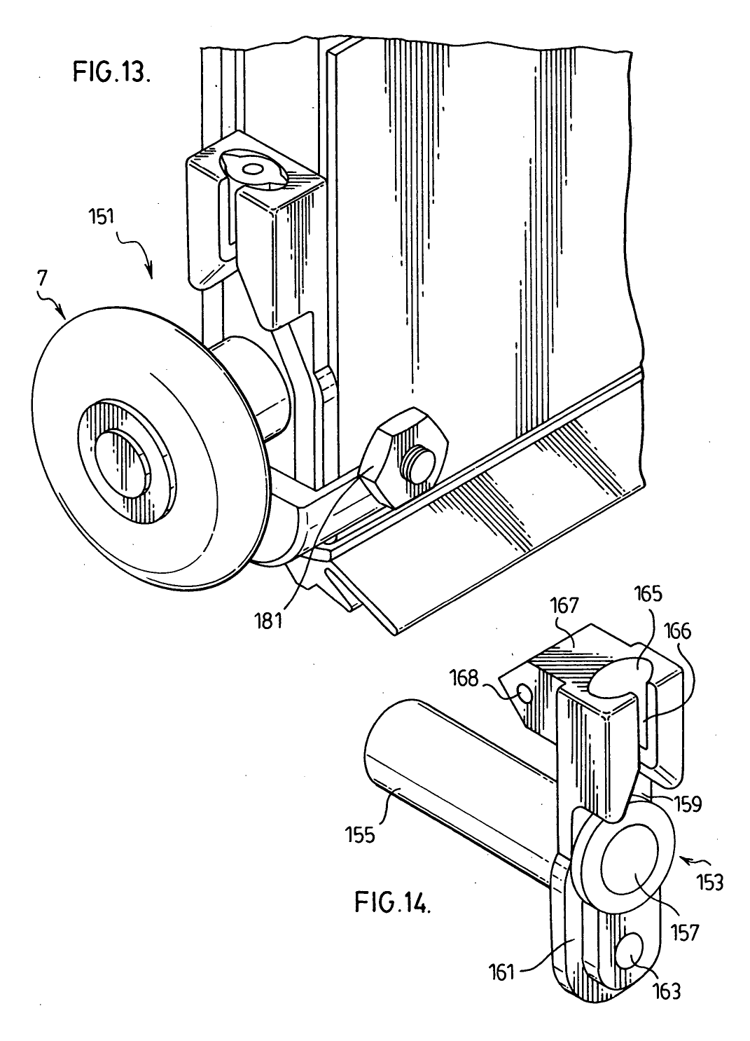

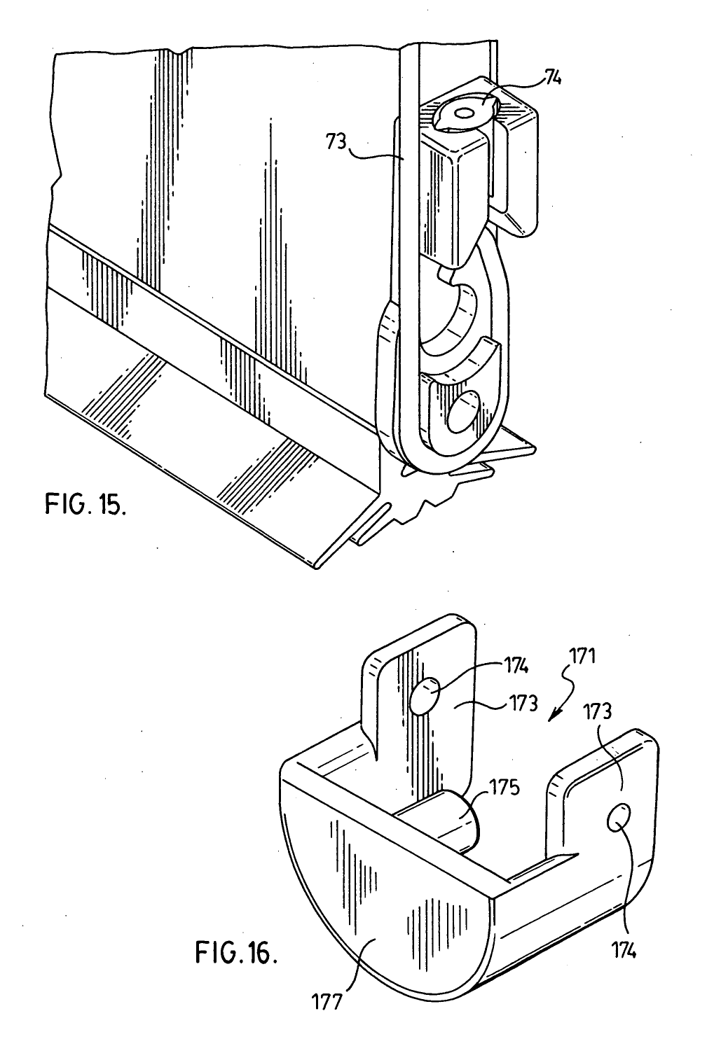

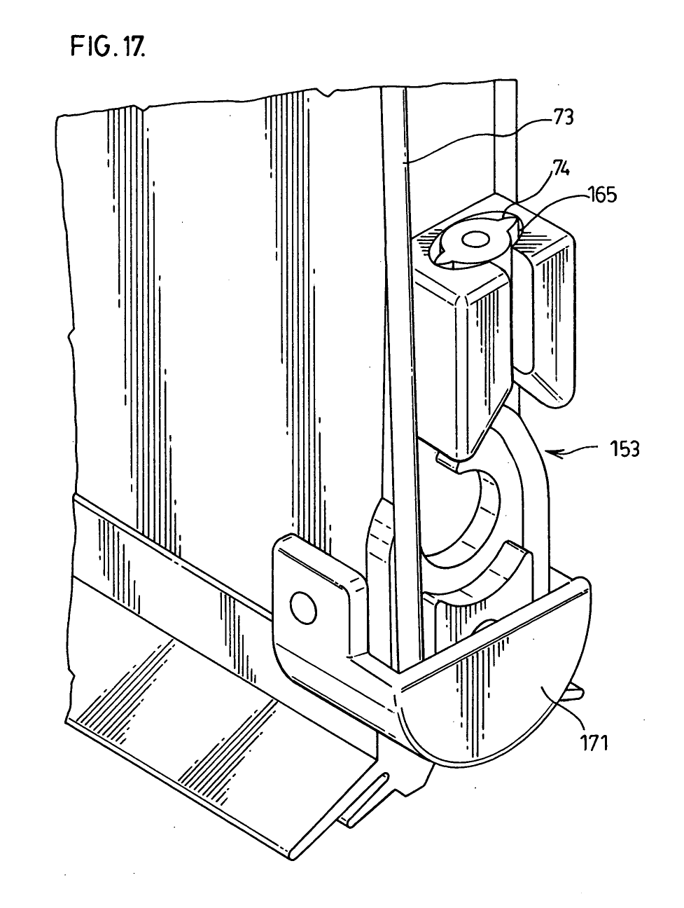

Assembly 151 is formed by two assembly components including component 153 as best seen in FIG. 14 of the drawings and component 171 best seen in FIG. 16 of the drawings.

Component 153 comprises a plug portion 155 which fits into the circular hollow chamber 17 within the panel. This positively locates component 153 at the door edge.

Component 153 includes a roller axle receiving bore 157 in plug portion 155. Therefore, component 153 additionally comprises a further roller mount.

Provided around the lower part of component 153 is a cable receiving ledge 161. Provided at the upper end of component 153 is a cable end trap 165 with a slot 166 feeding into the trap 165.

Tab 167 is provided to the rear of the upper side of the mounting component. This tab is used to stablize the mounting of component 153 at the door edge.

FIG. 15 of the drawings shows the first installation step of securing the cable mount and cable to the lower end of the door. In this first installation step cable mount component 153 is fitted against the door edge with both plug portion 155 and tab 167 penetrating the interior confines of the panel between the panel walls.

From here the cable 73 fitted with an end stop 74 is wrapped around the ledge 161 of the main body 159 of component 153. The extreme end part of the cable is slid through slot 166 where the cable end stop 74 is trapped within trap 165.

The next step in the installation is to fit component 171 of FIG. 16 with the now door mounted component 153. Component 171 includes a pair of leg portions 173 which fit to opposite sides of the door over component 153. In this position, component 171 traps the cable 73 against the ledge 161 of component 153.

Component 171 includes an interior post 175 which locates within the opening 163 of component 153. This prevents the two components from rocking relative to one another.

In order to complete the installation a securing bolt 181 is fitted through the opening 174 of legs 173 of component 171 where the legs wrap around the panel. This bolt extends completely through the panel from one leg to the other of component 171.

Although various preferred embodiments of the present invention have been described in detail, it will be appreciated by those skilled in the art that variations may be made without departing from the spirit of the invention or the scope of the appended claims.

1. A rolling door assembly comprising first and second corresponding plastic panels secured to one another by a hinged panel interlock, each panel having first and second interlock parts to opposite side edges of each panel, the hinged panel interlock being formed by the first interlock part of the first panel securing with the second interlock part of the second panel, each panel having end openings spaced to one side of the hinged panel interlock in opposite ends of each panel, each end opening being fitted with an insert having a plug portion with an elongated cylindrical bore which receives an axle of a door roller having a roller head adjacent to the side edge of the door assembly, each insert including a front face perpendicular to the plug portion against the panel edge that extends and overlaps the hinged panel interlock.

2. A rolling door assembly as claimed in claim 1 wherein said front face of each insert includes a projection which extends past the panel edge into the panel where the projection is secured to hold the insert within the panel.

3. A rolling door as claimed in claim 2 wherein the panel comprises an interior wall and an exterior wall separated by reinforcing foam material, said projection comprising projecting tabs of said insert having piercing tips for embedding the tabs within the foam material of the panel.

4. A rolling door assembly as claimed in claim 3 including a mechanical fastening member fitted through said interior wall of said panel and engaged with the tabs of the insert to secure the insert within the panel.

5. A rolling door assembly comprising first and second corresponding plastic panels secured to one another by a hinged panel interlock, each panel having first and second interlock parts to opposite side edges of each panel, the hinged panel interlock being formed by the first interlock part of the first panel securing with the second interlock part of the second panel, each panel having end openings spaced to one side of the hinged panel interlock in opposite ends of each panel, each end opening being fitted with an insert having a plug portion with an elongated cylindrical bore which receives an axle of a door roller having a roller head adjacent to the side edge of the door assembly; and wherein each panel comprises an outer panel wall separated from an inner panel wall by a hollow panel interior, said hollow panel interior comprising a major hollow region occupying most of the panel interior and a minor hollow region next to the hinged panel interlock, the major and minor hollow regions being separated by a neck part of the panel, the end opening being at the minor hollow region into which the plug of the insert is fitted trapped to opposite sides by the hinged panel interlock and the neck part of the panel.

6. A rolling door assembly as claimed in claim 5 wherein said minor hollow region has a circular cross section and wherein said plug portion has a circular cross section snugly held within said minor hollow region, and a face portion which is perpendicular to said plug portion and which is held against the panel edge.

7. A rolling door assembly comprising first and second corresponding plastic panels secured to one another by a hinged panel interlock, each panel having first and second interlock parts to opposite side edges of each panel, the hinged panel interlock being formed by the first interlock part of the first panel securing with the second interlock part of the second panel, each panel having end openings spaced to one side of the hinged panel interlock in opposite ends of each panel, each end opening being fitted with an insert having a plug portion with an elongated cylindrical bore which receives an axle of a door roller having a roller head adjacent to the side edge of the door assembly; and wherein said insert includes a second plug portion, said plug portion fitting into the edge opening of the panel remotely of the interlock and being connected to said second plug portion which fits into the hinged panel interlock which is recessed to receive said second plug portion, said cylindrical bore in which the axle of the door roller is received being located in said second plug portion of said insert.

8. A rolling door assembly as claimed in claim 7 wherein said first and second plug portions clamp, from opposite sides, on to a panel edge part where said hinged panel interlock is recessed to receive said second plug portion of said insert, said plug portion and said second plug portion being secured to one another through said panel end region to secure said insert with the panel.
